(19) United States
(12) Patent Application Publication
(10) Pub. No.: US 2026/0292074 A1
(43) Pub. Date: Sep. 24, 2026

(54) ABNORMALITY DETECTION APPARATUS, SCANNER, IMAGE FORMING APPARATUS, ADHERING OBJECT DETECTION METHOD, AND NON-TRANSITORY RECORDING MEDIUM

(71) Applicant: Tatsuro Koto, TOKYO (JP)

(72) Inventor: Tatsuro Koto, TOKYO (JP)

(73) Assignee: Ricoh Company, Ltd., Tokyo (JP)

(21) Appl. No.: 19/561,973

(22) Filed: Mar. 10, 2026

(30) Foreign Application Priority Data
Mar. 18, 2025 (JP) 2025-043630
Feb. 2, 2026 (JP) 2026-015421

(51) Int. Cl. H04N 1/00; G03G 15/00

(52) U.S. Cl. CPC H04N 1/00082; G03G 15/55; H04N 1/00013; H04N 1/00037; H04N 1/00045; H04N 1/00068; H04N 1/00074; H04N 1/00814; H04N 1/00824; H04N 2201/0081; H04N 2201/0094

(57) ABSTRACT

An abnormality detection apparatus includes an image reader, including a reading surface to read an image and multiple light-emitting elements, and circuitry. The circuitry is to calculate a position of an abnormality on the reading surface based on a reading result generated by the image reader, control turning on of the multiple light-emitting elements, and turn on one light-emitting element of the multiple light-emitting elements closest to the calculated position of the abnormality on the reading surface.

### CROSS-REFERENCE TO RELATED APPLICATIONS

This patent application is based on and claims priority pursuant to 35 U.S.C. § 119(a) to Japanese Patent Application Nos. 2025-043630, filed on Mar. 18, 2025, and 2026-015421, filed on Feb. 2, 2026, in the Japan Patent Office, the entire disclosure of which is hereby incorporated by reference herein.

### BACKGROUND

### Technical Field

The present disclosure relates to an abnormality detection apparatus, a scanner, an image forming apparatus, an adhering object detection method, and a non-transitory recording medium.

### Related Art

To detect a defect of an image forming apparatus, an output from the image forming apparatus is read by a scanner, and the read image is compared with a master image (a correct answer), to detect a defect on the output.

However, in a case where an abnormality occurs due to, for example, an object adhering to the reading surface of the scanner, the adhering object is reflected in the scanned image, and thus a defect may be erroneously detected. To prevent the detection of the adhering object as a defect, it is necessary to clean the reading surface of the scanner. Removing the adhering object from the reading surface involves locating the adhering object on the reading surface.

For example, it is proposed to use the fact that the document pressure plate (platen), which serves as the reading surface and is read through the exposure glass, has a prescribed degree of whiteness. In the proposed technique, a blank image is read, and the position of image data other than white image data is located as the position of the adhering object.

When the light source is moved in the sub-scanning direction and turned on to indicate the position of an adhering object, the user can recognize the position of the adhering object in the sub-scanning direction.

### SUMMARY

The present disclosure described herein provides an abnormality detection apparatus that includes an image reader, including a reading surface to read an image and multiple light-emitting elements, and circuitry. The circuitry is to calculate a position of an abnormality on the reading surface based on a reading result generated by the image reader, control turning on of the multiple light-emitting elements, and turn on one light-emitting element of the multiple light-emitting elements closest to the calculated position of the abnormality on the reading surface.

The present disclosure described herein provides a scanner including the abnormality detection apparatus described above. The abnormality is an object adhering to the reading surface.

The present disclosure described herein provides an image forming apparatus including the abnormality detection apparatus described above, and an image forming device to form the image. The abnormality is an object adhering to the reading surface.

The present disclosure described herein provides an adhering object detection method including reading an image with an image reader including multiple light-emitting elements, calculating a position of an object adhering to a reading surface of the image reader based on a result of reading the image, and turning on one light-emitting element, of the multiple light-emitting elements, closest to the calculated position of the object adhering to the reading surface.

The present disclosure described herein provides a non-transitory recording medium storing a plurality of program codes which, when executed by one or more processors, causes the one or more processors to perform a method. The method includes reading an image with an image reader including multiple light-emitting elements, calculating a position of an object adhering to a reading surface of the image reader based on a result of reading the image, and turning on one light-emitting element of the multiple light-emitting elements closest to the calculated position of the object adhering to the reading surface.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of an abnormality detection apparatus;

FIG. 2 is a diagram illustrating a configuration of an image reader included in a scanner as an example of an abnormality detection apparatus;

FIG. 3 is a diagram illustrating a configuration of a light source;

FIG. 4 is a diagram illustrating a read image in a case where an abnormality occurs on a reading surface when an image reader performs reading without sheet feeding;

FIG. 5 is a diagram illustrating a method of identifying a light-emitting diode (LED) to be turned on;

FIG. 6 is a diagram illustrating a message prompting cleaning of a reading surface, displayed on a display unit;

FIG. 7 is a diagram illustrating a method of indicating the position of abnormality on a reading surface;

FIG. 8 is a flowchart of a process of detecting an abnormality and issuing a notification that prompts cleaning by a scanner;

FIG. 9 is a block diagram illustrating a configuration of an image forming apparatus;

FIG. 10 is a block diagram of a hardware configuration of a printer included in an image forming apparatus; and

FIG. 11 is a diagram illustrating a functional configuration of a printer.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

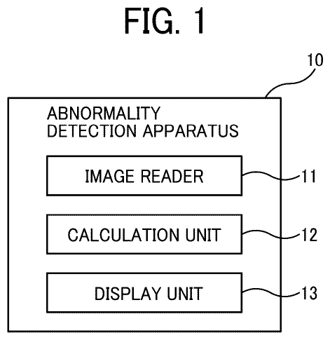

FIG. 1 is a block diagram illustrating a configuration of an abnormality detection apparatus 10. The abnormality detection apparatus 10 includes an image reader 11 having a reading surface to read an image, a calculation unit 12 to calculate the position of an abnormality occurring on the reading surface based on the read image, and a display unit 13 serving as a notification device to indicate the calculated position of the abnormality. The abnormality detection apparatus 10 may be any apparatus or system that includes the image reader 11, the calculation unit 12, and the display unit 13, and may be a scanner or an image forming apparatus, such as a multifunction peripheral (MFP). Examples of the abnormality occurring on the reading surface include adhesion of an object, such as dust or a foreign object to the reading surface, and a scratch on the reading surface. The following description will be made assuming that the abnormality is the adhesion of dust.

The image reader 11 reads an image formed (e.g., printed) on a rectangular thin sheet (for example, paper) and outputs image data. In the following description, a sheet to be read is a paper sheet. For example, the image reader 11 performs a blank scan in advance, with the reading surface free from dust adhering thereto, to generate a reference image. A blank scan refers to performing image reading without a sheet on which an image is formed, that is, performing image reading without paper feeding. The calculation unit 12 compares the result obtained by the blank scan (the read image) with the reference image, to determine the presence or absence of dust, and calculates the adhesion position of the dust based on the determination result indicating that dust adheres to the reading surface. Further, the calculation unit 12 may compare the result of reading a plain sheet on which no image is printed with the preliminary result of reading a plain sheet with no dust on the reading surface, to determine whether dust adheres and calculate the adhesion position of the dust, in addition to comparing the results of blank reading. The dust adhering to the reading surface is, for example, paper dust arising from the sheet, or toner peeled off from the image formed on the sheet.

When the image reader 11 moves to read the entire sheet which is fixed in position, the direction in which the image reader 11 moves is the sub-scanning direction. The direction perpendicular to the sub-scanning direction is the main scanning direction. By contrast, when the sheet that is moved to allow the image reader 11 fixed in position to read the entire sheet, the sub-scanning direction is the moving direction of the sheet. The direction perpendicular to the moving direction of the sheet is the main scanning direction. Specifically, in the case that a vertically long sheet is moved in the vertical direction, the vertical direction is the sub-scanning direction, and the horizontal direction is the main scanning direction. In the following description, it is assumed that the image reader 11 is fixed in position and the sheet is moved by a conveyor belt.

The calculation unit 12 determines that dust is on the reading surface when there is a portion where the pixel value is different between the result of the blank reading and the reference image obtained by the preliminary blank reading with no dust on the reading surface. The calculation unit 12 determines the presence or absence of dust based on the image obtained by the blank reading performed by the image reader 11 at each position in the sub-scanning direction. Accordingly, the left end of the image can be used as the reference position in the sub-scanning direction. The calculation unit 12 calculates the distance from the reference position to the position in the main scanning direction, thereby calculating the coordinates of the dust adhesion position.

The calculation unit 12 may include a memory for temporarily storing the result of the blank reading and storing the reference image obtained by the preliminary blank reading with the reading surface free from dust or debris, and an arithmetic and logic processor to perform calculations using the results. Examples of the memory include a read-only memory (ROM) and a random-access memory (RAM). Examples of the processor include a central processing unit (CPU). The processing of the calculation unit 12 is implemented by the CPU reading the program from the ROM to the RAM and executing the program. The calculation unit 12 may include a memory such as a hard disk drive (HDD) or a solid-state drive (SSD) other than the ROM and the RAM.

When the calculation unit 12 detects the adhesion of dust, the display unit 13 can display a message prompting the user to clean the reading surface, assuming that dust is adhering to the reading surface. The display unit 13 can display the position of the dust calculated by the calculation unit 12. The display unit 13 may be any device that displays the information, and may be a display.

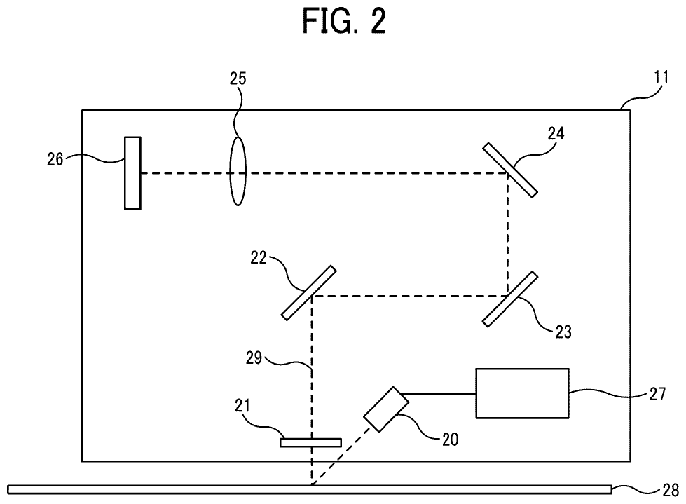

FIG. 2 is a diagram illustrating a configuration of the image reader 11 included in a scanner as an example of the abnormality detection apparatus 10. The scanner includes a document table on which a document to be read is placed, in addition to the image reader 11.

The image reader 11 includes a light source 20, an exposure glass 21 having a reading surface, a first mirror 22, a second mirror 23, a third mirror 24, a reading lens 25, and an imaging element 26 in order to read an image. The image reader 11 includes a control unit 27 that controls the lighting of the light source 20, but the control unit 27 may reside outside the image reader 11 as a control device. The control unit 27 may control not only the lighting of the light source 20 but also the entire operation of the image reader 11.

The light source 20 is an illumination device for obtaining transmitted light or reflected light of an image (for example, a document image) formed on a sheet 28. The image reader 11 may receive light transmitted through the sheet 28 to read an image, or may receive light reflected from the sheet 28 to read an image. In the following description, the image reader 11 receives the light reflected from the sheet 28 to read an image.

The exposure glass 21 protects the main body (housing) so that dust or foreign matter does not enter a reading optical axis 29 through which the light reflected from the sheet 28 passes. The main body has a door and contains the components, such as the light source 20. The first mirror 22, the second mirror 23, and the third mirror 24 guide the light reflected from the sheet 28 to the reading lens 25. The reading lens 25 is a lens for forming an image of the light reflected from the sheet 28 on the imaging element 26 to obtain a clear image.

The imaging element 26 is a semiconductor element that reads the light reflected from the sheet 28 imaged by the reading lens 25 and forms an image of the sheet 28. The imaging element 26 may be a charged-coupled device (CCD) image sensor or a complementary metal oxide semiconductor (CMOS) image sensor.

The control unit 27 is connected to the light source 20 and controls the lighting timing and the light amount of the light source 20. The control unit 27 may be implemented by, for example, a CPU, a ROM, and a RAM, similarly to the calculation unit 12 illustrated in FIG. 1. Accordingly, the control by the control unit 27 can be achieved by the CPU reading a program from the ROM to the RAM and executing the program.

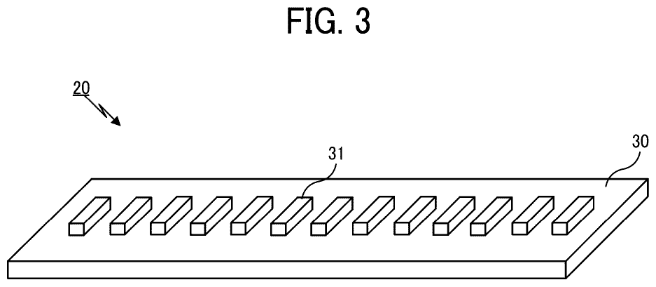

FIG. 3 is a diagram illustrating a configuration of the light source 20. The light source 20 includes a substrate 30 and multiple light-emitting elements. The light-emitting elements may be referred to as light sources. The light-emitting element may be, for example, light-emitting diodes (LED) 31. Multiple LEDs 31 are surface-mounted in a single row on the substrate 30. The longitudinal direction of the substrate 30 coincides with the main scanning direction.

The lighting timing and the light amount of the LEDs 31 are controlled by the control unit 27. The control unit 27 can turn on all the LEDs 31 at the same time, turn on only one LED 31, or turn on two or more LEDs 31 at the same time. Further, since the control unit 27 can control the light amount, the lighting pattern can be changed.

Accordingly, when dust adheres to the exposure glass 21 having the reading surface, the control unit 27 can turn on only the LED 31 closest to the adhesion position of the dust among the multiple LEDs 31 arrayed in the main scanning direction. This allows the user to easily determine the position of the dust in the main scanning direction on the exposure glass 21.

When multiple pieces of dust adhere to the exposure glass 21, the control unit 27 can turn on, from among the LEDs 31, the LEDs 31 closest to the respective pieces of dust.

In the notification of the dust adhesion position, the accuracy of the dust adhesion position can be changed by changing the interval between the LEDs 31 in the main scanning direction. For example, it is assumed that each LED 31 has the width of about 1 mm in the direction in which the LEDs 31 are arrayed on the substrate 30, and the interval between the LEDs 31 is about 6 mm in the direction of the array. In this case, the adhesion position of the dust is calculated with an accuracy of ±3 mm from the center of the width of the LED 31.

The LEDs 31 are preferably arranged at equal intervals over the entire length of the exposure glass 21 in order to reduce brightness unevenness in the main scanning direction of the read image.

The calculation unit 12 calculates the size of the dust as well as the adhesion position of the dust by the comparison between the read image and the reference image. Accordingly, the control unit 27 turns on the LED 31 closest to the adhesion position of the dust, and changes its light amount according to the size of the dust, thereby changing the lighting pattern according to the size of the dust. Changing the lighting pattern is not limited to changing the light amount. For example, the blinking pattern (the time of lighting and turning off) may be changed.

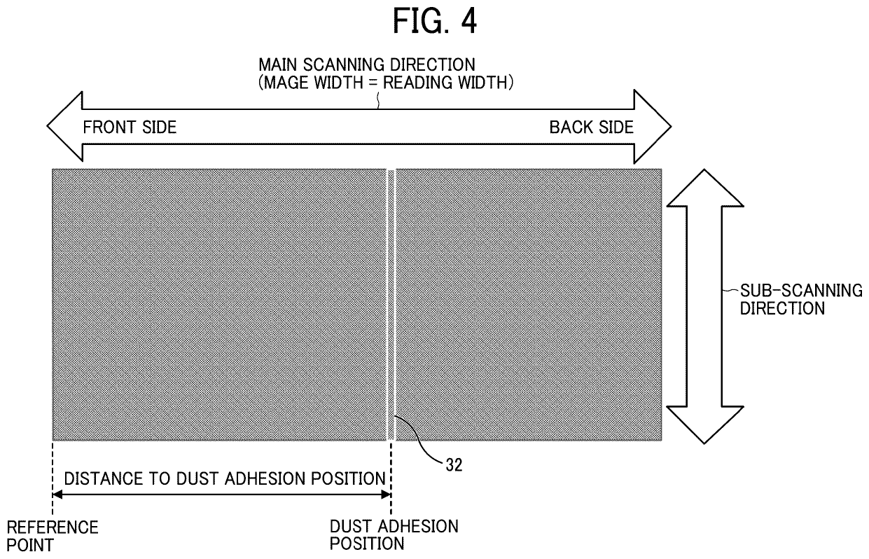

FIG. 4 is a diagram illustrating a read image in a case where dust adheres to the reading surface when the image reader 11 performs reading without sheet feeding. The horizontal direction of the image read by the image reader 11 matches the main scanning direction, and the width of the image matches the reading width.

When dust adheres to a certain position of the reading surface in the main scanning direction, the conveyance passage for conveying the sheet is read with the dust remains on the reading surface. Thus, the read image includes a reading streak 32 extending in the sub-scanning direction as illustrated in FIG. 4.

Accordingly, by using the left end of the image as the reference point, the calculation unit 12 calculates, based on this image, the distance from the reference point to the dust adhesion position on the reading surface in the main scanning direction, thereby locating the dust adhesion position in the main scanning direction.

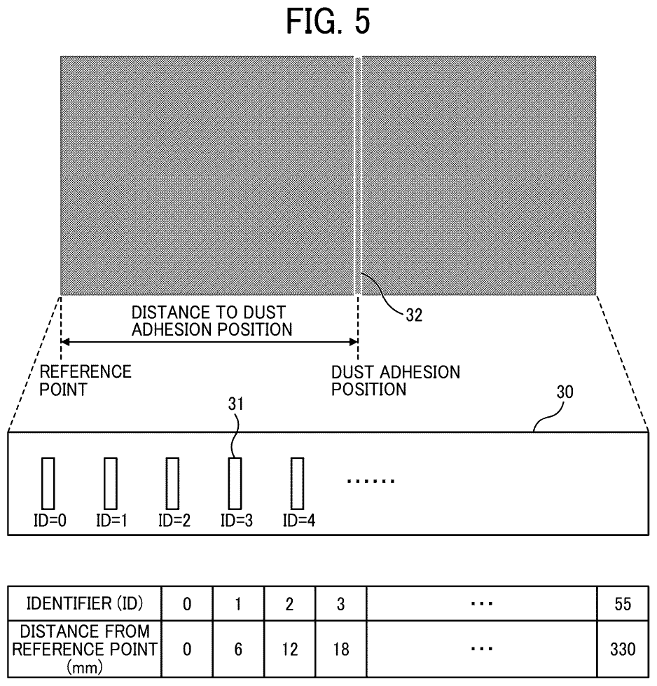

FIG. 5 is a diagram illustrating a method of identifying an LED to be lit from among the LEDs 31. The LEDs 31 are individually given identification information uniquely determined, and the distances from the reference point at the left end of the read image are mapped. For example, the identification information is an identifier (ID). The control unit 27 holds the distance (in millimeters) to each of the LEDs 31 from the reference point in advance. The control unit 27 holds the IDs and the distances in any desired form, such as a table, in which the IDs and the distances are associated with each other, as illustrated in FIG. 5.

The control unit 27 calculates the difference between the distance from the reference point to the adhesion position of the dust calculated by the calculation unit 12 and the individual distances of the LEDs 31 from the reference point held in advance. The control unit 27 then identifies the LEDs 31 having the smallest value as the LED closest to the dust adhesion position, and stores the ID assigned to the identified LED 31. Then, the control unit 27 controls the LED 31 having the stored ID to light up.

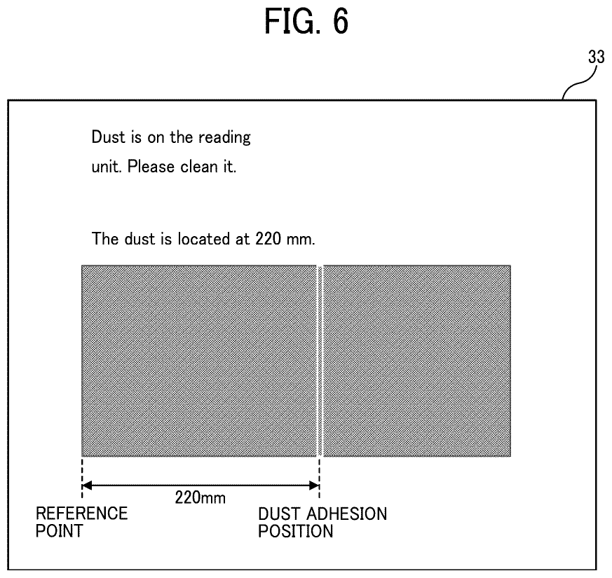

FIG. 6 is a diagram illustrating a message prompting cleaning of the reading surface, displayed on the display unit 13. The display unit 13 includes a display screen 33. When dust adhering to the reading surface is detected by the calculation unit 12, the display unit 13 displays on the display screen 33 a message (e.g., “Dust is on the reading unit.”) notifying the user that dust is adhering to the reading unit. In addition, to inform the user of an action to be taken in response to dust adhering to the reading surface, the display unit 13 displays on the display screen 33 a message, such as “Please clean the reading surface.”

The display unit 13 may include in the message the distance in the main scanning direction from the reference point to the adhesion position of the dust calculated by the calculation unit 12. Thus, the adhesion position of the dust in the main scanning direction is displayed.

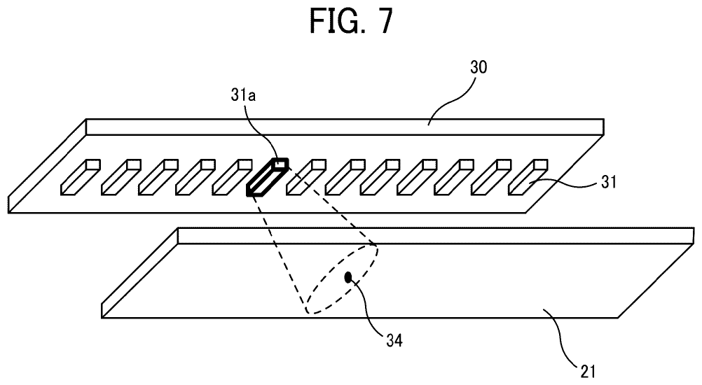

FIG. 7 is a diagram illustrating a method of indicating a dust adhesion position on the reading surface. The calculation unit 12 calculates the distance from the reference point to the adhesion position of the dust in the main scanning direction. Accordingly, the control unit 27 determines to turn on an LED 31a closest to the position of dust 34 on the reading surface of the exposure glass 21, among the multiple LEDs 31 arrayed in the main scanning direction of the light source 20. The distances of the LEDs 31 from the reference point on the image in the main scanning direction are determined, which allows the determination of the LED 31 closest to the calculated distance as the LED 31 to be turned on.

The control unit 27 controls the LED 31a to turn on, and the exposure glass 21 in a range adjacent to the LED 31a is irradiated with light by the turning on of the LED 31a. Since the specific range of the exposure glass 21 including the dust 34 is irradiated with the light from the LED 31a designated to be turned on, the dust 34 on the exposure glass 21 is irradiated with the light. Thus, the position of the dust 34 can be easily located.

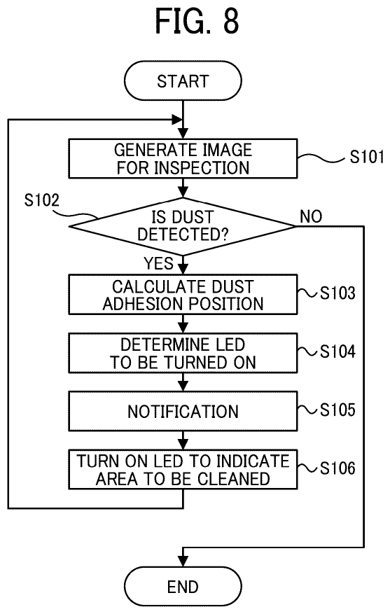

FIG. 8 is a flowchart of a process of detecting dust adhesion and issuing a notification that prompts cleaning by the scanner. When the abnormality detection apparatus 10 starts the process, in step S101, the image reader 11 generates a read image without sheet feeding, and notifies the calculation unit 12 and the display unit 13 that the image for inspection has been generated. The read image is an image to be inspected for detecting dust.

In step S102, the calculation unit 12 analyzes the generated image for inspection and determines whether dust adheres to the reading surface. When it is determined in step S102 that no dust adheres, the process is ended. By contrast, when it is determined in step S102 that dust adheres, the process proceeds to step S103. The calculation unit 12 calculates the adhesion position of the dust in the main scanning direction based on the image for inspection. The calculation unit 12 notifies the control unit 27 and the display unit 13 of the reference point and the calculated distance in the sub-scanning direction.

In step S104, the control unit 27 identifies the LED 31 to be turned on among the multiple LEDs 31. The control unit 27 identifies the LED 31a closest to the dust adhering to the reading surface based on the notified reference point and distance.

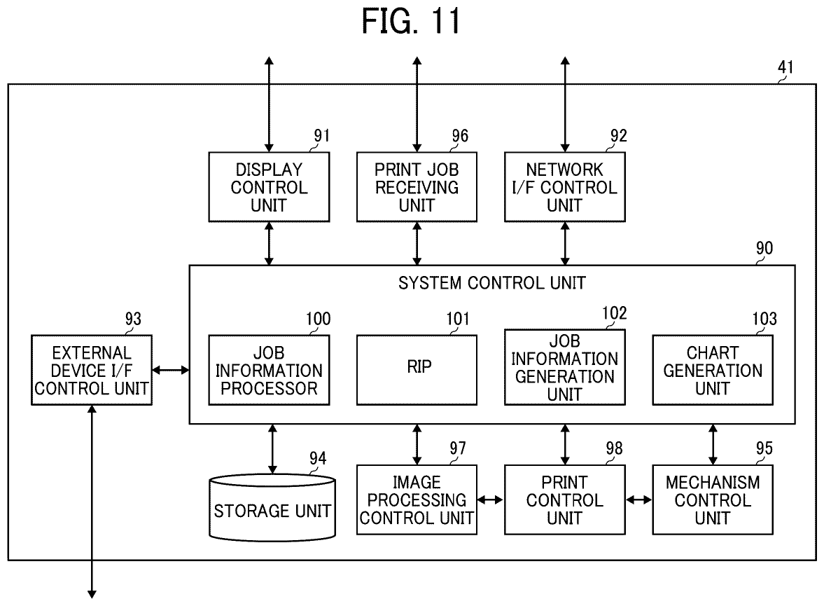

In step S105, the display unit 13 receives the notification that dust adheres to the reading surface from the calculation unit 12, and displays a message prompting cleaning, thereby notifying the user that dust adheres to the reading surface. A display control unit 91 illustrated in FIG. 11 may generate, based on the detection result generated by the calculation unit 12, screen information, which is information defining contents to be displayed on a screen, and is described in a data format. In this case, the display unit 13 displays the message based on the screen information. The display unit 13 receives the distance from the calculation unit 12 and displays the distance in the main scanning direction from the reference point to the adhesion position of the dust, in addition to the message.

In step S106, the control unit 27 controls the LED 31a, which is closest to the adhesion position of the dust, to turn on based on the distances in the main scanning direction from the reference point to the adhesion position of the dust. The control unit 27 can detect that the user has opened the door of the main body and turn on the LED 31a. The user can easily determine the position of the dust by looking at the range of the reading surface lit by the LED 31a. The user can clean the determined portion of the reading surface by using a cleaning tool, such as a cloth. After cleaning completes, the process returns to step S101. After the cleaning is completed, the control unit 27 detects that the door of the main body is closed. Then, the process is repeated from step S101 in which the image reader 11 generates the image for inspection again, to detect dust.

As described above, the system, the apparatus, the method, and the program according to the above-described embodiments allow the user to easily determine the position of the dust adhering to the reading surface in the main scanning direction. Further, since the position of the dust can be easily located, the effect of cleaning can be easily determined. The user can know the position of the abnormality based on the distance displayed on the display unit 13.

The display unit 13 can display a preview image in which a rectangle is superimposed on the image for inspection at the dust adhesion position. The rectangle indicates the dust adhesion position. This allows the user to recognize the approximate position of the dust adhesion before cleaning is performed, in addition to allowing the user to recognize that dust adheres to the reading surface and cleaning is necessary.

When multiple pieces of dust adhere to the reading surface, the calculation unit 12 calculates the distances from the reference point to the respective dust adhesion positions in the main scanning direction. The control unit 27 can turn on one or more LEDs 31 closest to each of the dust adhesion positions. Accordingly, even if multiple pieces of dust adhere to the reading surface, the respective dust adhesion positions can be notified to the user by turning on one or more LEDs 31.

The above-described aspects of the present disclosure are applicable to an image forming apparatus, such as an MFP, including an image reader. The image forming apparatus includes the image reader of the scanner as a reading unit, and further includes an image forming unit as an image forming device that forms an image.

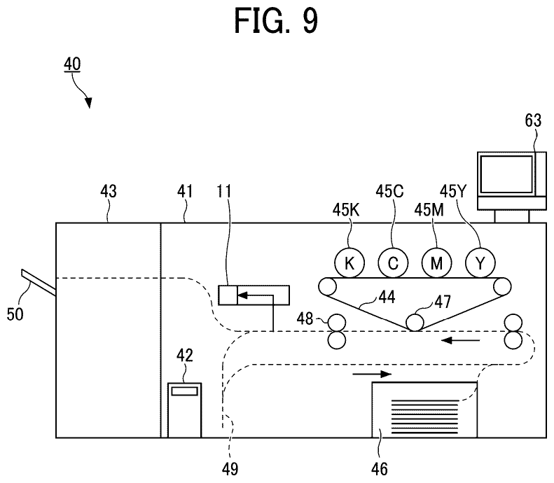

FIG. 9 is a block diagram illustrating a system configuration of an image forming apparatus 40. The image forming apparatus 40 includes a printer 41, an inspection device 42, and a stacker 43. These components are communicatively connected via a communication line or a communication network.

The printer 41 receives print job data, including an image received from an external device, such as a digital front end (DFE) apparatus, operated by the user. The printer 41 executes printing in response to an execution instruction included in the received print job data or a user's operation received on, for example, a control panel. The print job data includes image data, and job information indicating the attributes of the image data, such as the number of copies to be printed, the number of pages, printing method (double-sided or single-sided printing), and sheet type.

The printer 41 includes photoconductor drums 45Y, 45M, 45C, and 45K disposed along a conveyor belt 44 that is an endless conveyor.

Specifically, the printer 41 includes the photoconductor drums 45Y, 45M, 45C, and 45K disposed in this order from upstream in the traveling direction of the conveyor belt 44. The conveyor belt 44 is an intermediate transfer belt on which an intermediate transfer image is formed. The intermediate transfer image is to be transferred onto a sheet fed from a sheet feeding tray 46 along the conveyor belt 44. In this description, the sheet is an example of a recording medium on which a color image is formed.

The printer 41 transfers black (K), cyan (C), magenta (M), and yellow (Y) toner images, which are developed with the toner on the respective surfaces of the photoconductor drums 45Y, 45M, 45C, and 45K, onto the conveyor belt 44 in a superimposed manner to form a full-color image. These colors are examples of a first color and a second color, and the toner images of these colors are examples of multiple images that are superimposed one on another on a recording medium to form a color image.

The printer 41 transfers, with a transfer roller 47, the full-color image from the conveyor belt 44 onto the sheet, which is conveyed through the conveyance passage indicated by the broken line in FIG. 9, at the position closest to the conveyance passage.

The printer 41 further conveys the sheet on which the image is formed, fixes the image with a fixing roller 48, and conveys the sheet to the image reader 11. The image reader 11 reads the sheet conveyed via the fixing roller 48, generates read image data, and inputs the read image data to the inspection device 42. The read image is, for example, a red-green-blue (RGB) image having 8 bits per color and a resolution of 200 dpi, in which one pixel corresponds to a width of approximately 0.127 mm. The image reader 11 may obtain an image after the toner is fixed with the fixing roller 48, or may obtain an image transferred by the transfer roller 47 but not yet conveyed to the fixing roller 48.

In single-sided printing, the printer 41 directly ejects the sheet read by the image reader 11 to the stacker 43. In duplex printing, the printer 41 reverses the sheet read by the image reader 11 through a reversing passage 49, and then conveys the sheet again to the transfer position by the transfer roller 47.

The printer 41 then transfers and fixes a toner image to the opposite side of the sheet having the printed image on one side. The image reader 11 reads the printed surface. The printer 41 then ejects the duplex printed sheet to the stacker 43.

The stacker 43 stacks and stores the sheets ejected from the printer 41 on a sheet ejection tray 50.

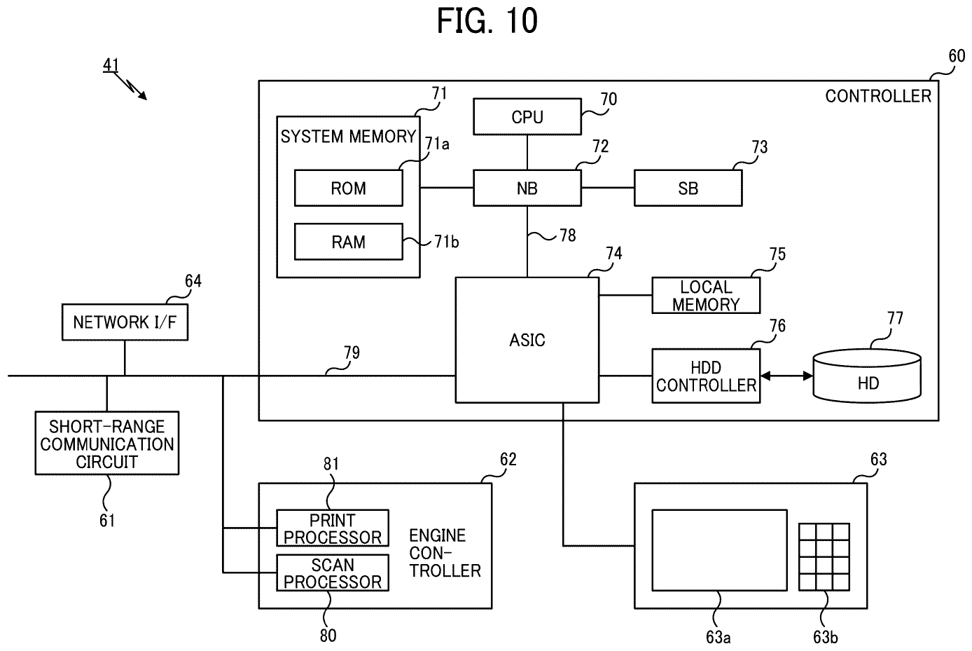

The inspection device 42 inspects the read image read by the image reader 11, and detects, for example, a positional error (positional error information) occurring during printing and an abnormality on the reading surface. Accordingly, the inspection device 42 functions as the calculation unit 12 of the abnormality detection apparatus. In the configuration illustrated in FIG. 9, the image reader 11 is fixed. To detect an abnormality of the reading surface, the conveyor belt 44 is read without sheet feeding, and the abnormality of the reading surface is detected from the read result. The sub-scanning direction is the direction in which the sheet is conveyed (the direction from the fixing roller 48 toward the stacker 43), and the main scanning direction is the direction perpendicular to the direction in which the sheet is conveyed. The information indicating the inspection result generated by the inspection device 42 is displayed on a control panel 63 (FIG. 10).

FIG. 10 is a block diagram of a hardware configuration of the printer 41 included in an image forming apparatus 40. The printer 41 includes a controller 60, a short-range communication circuit 61, an engine controller 62, the control panel 63, and a network interface (I/F) 64.

The controller 60 includes a CPU 70, a system memory 71, a north bridge (NB) 72, a south bridge (SB) 73, and an application-specific integrated circuit (ASIC) 74. The controller 60 further includes a local memory 75, an HDD controller 76, an HD 77, and an Accelerated Graphics Port (AGP) bus 78 that connects the NB 72 and the ASIC 74.

The CPU 70 controls the entire operation of the image forming apparatus 40 including the printer 41. The NB 72 is a bridge for connecting the CPU 70, the system memory 71, the SB 73, and the AGP bus 78. The NB 72 includes a memory controller for reading from or writing to the system memory 71, a peripheral component interconnect (PCI) master, and an AGP target.

The system memory 71 includes a ROM 71a and a RAM 71b. The ROM 71a stores data and programs for implementing various functions of the controller 60. The RAM 71b is used for loading the program and the data and is also used as a memory for deploying programs or data or as a memory for loading drawing data in printing. The program stored in the RAM 71b may be stored in a computer-readable recording medium, such as a compact disc-read-only memory (CD-ROM), a compact disc-recordable (CD-R), or a digital versatile disc (DVD) in a file of an installable format or an executable format.

The SB 73 is a bridge that electrically connects the NB 72 to PCI devices and peripheral devices. The ASIC 74 is an integrated circuit (IC) dedicated to image processing and has a hardware element for image processing. The ASIC 74 is a bridge that connects the AGP bus 78, a PCI bus 79, the HDD controller 76, and the local memory 75. The ASIC 74 includes a PCI target, an AGP master, an arbiter (ARB) as a central processing unit of the ASIC 74, a memory controller for controlling the local memory 75, multiple Direct Memory Access controllers (DMACs) to rotate image data with a hardware logic, and a PCI unit that transfers data between a scan processor 80 and a print processor 81 via the PCI bus 79. The ASIC 74 may be connected to a universal serial bus (USB) interface, or the Institute of Electrical and Electronics Engineers 1394 (IEEE1394) interface.

The local memory 75 is used as a buffer for an image to be copied or a buffer for coding. The HD 77 is a storage device that stores image data, font data for printing, and form data. The HD 77 controls the reading or writing of data to or from the HD 77 under the control of the CPU 70. The AGP bus 78 is a bus interface for a graphics accelerator card, which is proposed to accelerate graphics processing. The speed of the graphics accelerator card is increased through direct access to the system memory 71 by high-throughput.

The short-range communication circuit 61 is a communication circuit compliance with a protocol, such as near field communication (NFC) or Bluetooth^{®}. The engine controller 62 includes the scan processor 80 and the print processor 81.

The control panel 63 includes a panel display 63a, such as a touch screen, and an input unit 63b. The panel display 63a displays current setting values or a selection screen and receives a user input. The input unit 63b includes a numeric keypad to receive setting values for various image forming parameters, such as an image density parameter, and a start key to receive an instruction to start, e.g., copying. The controller 60 controls the entire operation of the image forming apparatus 40 including the printer 41, and controls, for example, drawing, communication, and input from the control panel 63. The scan processor 80 reads the image formed on a medium being conveyed such as a sheet of paper to generate image data. The print processor 81 controls image forming engines to form an image with a colorant, such as toner, on a conveyed sheet, such as a paper sheet. The mage forming engines include a transfer device to transfer the image onto the conveyed sheet, a fixing device to fix the image, and a heating device or a drying device. The scan processor 80 and the print processor 81 include an image processor for various image processing, such as error diffusion or gamma conversion.

In the image forming apparatus 40, an application switching key on the control panel 63 allows the function to be sequentially switched and selected among a document server function, a copy function, a print function, and a facsimile function. The apparatus enters the document server mode to store document data when the document server function is selected, enters the copy mode when the copy function is selected, enters the printer mode when the print function is selected, and enters the facsimile mode when the facsimile function is selected.

The network I/F 64 is an interface for data communication through a communication network. The short-range communication circuit 61 and the network I/F 64 are electrically connected to the ASIC 74 through the PCI bus 79.

The medium being conveyed is not limited to a paper sheet. The medium to be conveyed may be any sheet that is placed on the sheet feeding tray included in the printer 41 and is conveyed and output in response to an instruction to output the medium. Examples of the medium include a film sheet and a plastic sheet. The image forming apparatus is not limited to an apparatus including the electrophotographic printer 41 as described above, and may be, for example, an inkjet printer.

FIG. 11 is a diagram illustrating a functional configuration of the printer 41. The printer 41 includes a system control unit 90, a display control unit 91, a network I/F control unit 92, an external device I/F control unit 93, a storage unit 94, a mechanism control unit 95, a print job receiving unit 96, an image processing control unit 97, and a print control unit 98. Each of these units is implemented by the CPU 70 or the ASIC 74 executing a process defined in programs stored in the system memory 71 or the local memory 75.

The system control unit 90 controls the entire operation of the printer 41. The system control unit 90 includes a job information processor 100, a raster image processor (RIP) 101, a job information generation unit 102, and a chart generation unit 103.

The job information processor 100 processes job information included in print job data transmitted from, for example, a DFE apparatus. The RIP 101 processes RIP image data included in print job data transmitted from, for example, the DFE apparatus. The RIP image is, for example, a 600-dpi image in which the CMYK color components are each 8 bits, and is an example of print data (image forming data). The acronym “dpi” denotes dots per inch.

In response to receiving from the inspection device 42 the information instructing the insertion of a sheet on which an image for inspection is formed, the job information generation unit 102 generates job information for inserting the sheet.

The chart generation unit 103 generates print data in which an inspection chart to be inspected is arranged. The chart generation unit 103 is an example of an image arrangement unit, and the print data in which the inspection chart is arranged is an example of the image formation data.

The display control unit 91 controls the display of various information including job information on the control panel 63. The network I/F control unit 92 controls the network I/F 64 and controls the connection with the communication network. When another device is connected to the apparatus, the external device I/F control unit 93 controls the connection with the connected device. The storage unit 94 stores various types of information including job information.

The mechanism control unit 95 controls the operations of the mechanisms in the printer 41. The operations of the printer 41 include sheet conveyance and a transfer process. The print job receiving unit 96 receives the print job data from, for example, a DFE. The image processing control unit 97 processes the print image transferred by the mechanism control unit 95. The print control unit 98 controls image formation on the conveyed medium. The mechanism control unit 95, the image processing control unit 97, and the print control unit 98 cooperate with each other to function as an image forming unit that forms an image on the conveyed medium.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An abnormality detection apparatus comprising:
an image reader including a reading surface to read an image, and multiple light-emitting elements; and
circuitry configured to:
calculate a position of an abnormality on the reading surface based on a reading result generated by the image reader;
control turning on of the multiple light-emitting elements; and
turn on one light-emitting element of the multiple light-emitting elements closest to the calculated position of the abnormality on the reading surface.

2. The abnormality detection apparatus according to claim 1, further comprising a notification device to indicate the calculated position of the abnormality on the reading surface.

3. A scanner comprising the abnormality detection apparatus according to claim 1,
wherein the abnormality is an object adhering to the reading surface.

4. The scanner according to claim 3, wherein
the image reader is to compare a read image and a reference image, to determine whether the object adheres to the reading surface,
the read image is obtained by performing reading without sheet feeding or reading a blank sheet,
the reference image is obtained in advance by performing reading without sheet feeding or reading the blank sheet, when the reading surface is free from an adhering object, and
the circuitry calculates the position of the object adhering to the reading surface based on a determination result indicating that the object adheres to the reading surface.

5. The scanner according to claim 4,
wherein the circuitry sets one end of the read image in a main scanning direction as a reference point, and calculates a distance from the reference point as the position of the object adhering to the reading surface in the main scanning direction.

6. The scanner according to claim 3, further comprising a notification device to prompt cleaning of the reading surface and indicate the calculated position of the object adhering to the reading surface.

7. The scanner according to claim 3,
wherein, when multiple objects, including the object, adhere to the reading surface, the circuitry turns on the one light-emitting element for each of the multiple objects.

8. The scanner according to claim 3,
wherein the circuitry is further configured to:
calculate a size of the object adhering to the reading surface; and
change a lighting pattern of the one light-emitting element according to the size of the object adhering to the reading surface.

9. An image forming apparatus comprising:
the abnormality detection apparatus according to claim 1; and
an image forming device to form the image, wherein the abnormality is an object adhering to the reading surface.

10. An adhering object detection method comprising:
reading an image with an image reader including multiple light-emitting elements;
calculating a position of an object adhering to a reading surface of the image reader based on a result of reading the image; and
turning on one light-emitting element of the multiple light-emitting elements, the one light-emitting element being closest to the calculated position of the object adhering to the reading surface.

11. A non-transitory recording medium storing a plurality of program codes which, when executed by one or more processors, causes the one or more processors to perform a method, the method comprising:
reading an image with an image reader including multiple light-emitting elements;
calculating a position of an object adhering to a reading surface of the image reader based on a result of reading the image; and
turning on one light-emitting element of the multiple light-emitting elements closest to the calculated position of the object adhering to the reading surface.
